(19) United States
(12) Patent Application Publication
(10) Pub. No.: US 2020/0287195 A1
(43) Pub. Date: Sep. 10, 2020

(54) METAL TAB FOR FLEXIBLE BATTERY

(71) Applicant: LiBEST INC., Yuseong-gu (KR)

(72) Inventors: Joo Seong KIM, Daejeon (KR); Jin Hong HA, Daejeon (KR); Gil Ju LEE, Daejeon (KR)

(21) Appl. No.: 16/878,909

(22) Filed: May 20, 2020

Related U.S. Application Data
(63) Continuation of application No. PCT/KR2018/013891, filed on Nov. 14, 2018.

(30) Foreign Application Priority Data
Nov. 20, 2017 (KR) 10-2017-0154499

(51) Int. Cl. H01M 2/26; H01M 4/66; H01M 10/052

(52) U.S. Cl. CPC H01M 2/26; H01M 10/052; H01M 4/662; H01M 4/661

(57) ABSTRACT

A metal tab included in a lithium secondary battery, wherein the lithium secondary battery includes a first electrode and a second electrode having different polarities with a separator interposed therebetween, and the metal tab is provided only on a first electrode tab protruded and extended from the first electrode, and a current collector of the first electrode has a Young's modulus equal to or less than that of a current collector of the second electrode.

### TECHNICAL FIELD

The present disclosure relates to a metal tab for a flexible battery.

### BACKGROUND

A secondary battery refers to a battery that may be charged and discharged and re-charged, as opposed to a primary battery which cannot be re-charged, and has been widely used in the field of advanced electronic devices such as cellular phones, notebook computers, camcorders, and other portable electronic devices. As portable electronic devices are designed and manufactured to be lighter in weight with improved performance, and further taking into consideration advancements in the Internet of Things (loT), secondary batteries as power supplies therefor are the subject of advanced research and development.

Among secondary batteries, lithium secondary batteries have a higher voltage than nickel-cadmium batteries or a nickel-hydrogen batteries mainly used as power supplies for portable electronic devices and also has a high energy density per unit weight. Therefore, demand for lithium secondary batteries is on the increase.

Secondary batteries utilize an electrochemical reaction occurring between an electrolyte and a positive electrode and the electrolyte and a negative electrode when the positive electrode and the negative electrode are connected to each other while they are inserted into the electrolyte. Unlike conventional primary batteries, the secondary battery is a chargeable and dischargeable battery that can be recharged with energy by a charger and used again when energy is consumed by an electronic device.

Typically, lithium secondary batteries include any one of a jelly-roll type electrode assembly in which a separator is inserted between a positive electrode and a negative electrode, which are then spirally wound together, or a stacked type electrode assembly in which multiple positive electrodes and negative electrodes are stacked with a separator interposed therebetween. For example, a cylindrical battery is manufactured by housing the jelly-roll type electrode assembly in a cylindrical can, injecting an electrolyte therein, and sealing the can. A prismatic battery is manufactured by pressing the jelly-roll type electrode assembly or the stacked type electrode assembly to be flat, and then housing the flat electrode assembly in a prismatic can. Further, a pouch type battery is manufactured by packing the jelly-roll type electrode assembly or the stacked type electrode assembly together with an electrolyte in a pouch type casing. In such electrode assemblies, a positive electrode tab and a negative electrode tab are withdrawn from a positive electrode and a negative electrode, respectively, to the outside of the electrode assembly and then connected with a positive electrode and a negative electrode of a secondary battery.

Meanwhile, an electrode tab on multiple positive electrodes and negative electrodes stacked in a vertical direction is connected to an electrode lead. A conventional joint structure between an electrode tab and an electrode lead slightly decreases in coherence during direct welding. Thus, when a battery is bent or distorted during use, a problem occurs in the joint between the electrode tab and the electrode lead.

According to conventional technologies, when a typical battery assembly is bent, compressive stress is applied to an inner bent portion and tensile stress is applied to the opposite side. Therefore, a casing covering an electrode assembly of the battery is also expanded or contracted, and, thus, mechanical damage occurs locally.

Further, in a current collector of a typical lithium secondary battery, a path through which electrons generated from an active material can flow to the outside is provided and electrode tabs protruded and extended from electrodes having different polarities are respectively made of metals having different properties. For example, a negative electrode current collector is mainly made of copper. This is because aluminum reacts with lithium to produce an alloy at a negative electrode operating potential. However, copper does not involve in oxidation-reduction reaction at an negative electrode operating potential and thus is stable. Here, a metal current collector made of, e.g., aluminum having a low Young's modulus and a metal current collector made of, e.g., copper having a relatively high Young's modulus are used together.

### Problems to be Solved

The present disclosure provides a method for solving a mechanical problem with a battery, which may occur in a flexible device.

### Means for Solving the Problems

To solve the above-described problem, there is provided a metal tab included in a lithium secondary battery according to at least one embodiment of the present disclosure, and the lithium secondary battery includes a first electrode and a second electrode having different polarities with a separator interposed therebetween, and the metal tab is provided on a first electrode tab protruded and extended from the first electrode, and the first electrode has a Young's modulus equal to or less than that of the second electrode.

When a current collector of the first electrode is made of aluminum, a current collector of the second electrode is made of aluminum or stainless steel.

When a current collector of the first electrode is made of copper, a current collector of the second electrode is made of stainless steel.

A maximum bend angle of the lithium secondary battery has an internal angle in the range of from 10° to 180°.

The metal tab is made of a metal having a Young's modulus equal to or greater than that of the current collector of the first electrode and having a thickness from one to five times greater than that of the current collector of the first electrode.

In the lithium secondary battery including a metal tab according to another aspect of the present disclosure, a first electrode lead is provided on the metal tab provided on the first electrode tab, and Young's moduli of the current collector of the first electrode, the metal tab and the first electrode lead satisfy the relationship that a young's modulus of the first electrode lead is equal to or larger than a young's modulus of the metal tab, and the young's modulus of the metal tab is equal to or larger than a young's modulus of the current collector of the first electrode.

When the current collector of the first electrode has a Young's modulus equal to or less than that of a current collector of the second electrode, a second electrode lead joined on a second electrode tab protrudes and extends from the second electrode having a bending structure that is bent 180° in an opposite direction toward the outside of an electrode assembly included in the lithium secondary battery where it has been provided on the second electrode tab toward the electrode assembly.

When the current collector of the first electrode has a lower Young's modulus than the current collector of the second electrode, the second electrode lead is provided on the second electrode tab protruding and extending from the second electrode, and Young's moduli of the current collector of the first electrode, the current collector of the second electrode, the metal tab, the first electrode lead and the second electrode lead satisfy a relationship that the a young's modulus of the current collector of the second electrode is equal to or larger than a young's modulus of the first electrode lead, the young's modulus of the first electrode lead is equal to or larger than a young's modulus of the metal tab, the young's modulus of the metal tab is equal to or larger than a young's modulus of the current collector of the first electrode, and the young's modulus of the current collector of the first electrode is equal to or larger than a young's modulus of the second electrode lead.

When the current collector of the first electrode has the same Young's modulus as the first electrode lead, the first electrode lead has a bending structure.

The electrode assembly included in the lithium secondary battery includes a first electrode and a second electrode that have different polarities and are alternately stacked with a separator interposed therebetween, and a pair of outermost electrodes placed on both sides of the electrode assembly includes a first electrode having a single surface coated with an electrode mixture.

A metal tab is provided on at least one of electrode tabs of the pair of outermost electrodes.

The lithium secondary battery includes mixture layers having different polarities and coated on the current collectors of the first and second electrodes, respectively, and electrode tabs not coated with the mixture layers and placed on the current collectors of the first and second electrodes, respectively, and the lithium secondary battery is sealed in a pouch including an electrode lead portion that is provided on the electrode tab and protruded to the outside of the lithium secondary battery to make electrons flow.

### Effects

According to the present disclosure, a metal tab connected to an electrode lead having a greater thickness is used on an electrode having elongation and bendability equal to or lower than predetermined levels. Accordingly, a separation problem between the electrode and the lead caused by a difference in thickness and elongation can be effectively resolved.

### BRIEF DESCRIPTION OF THE DRAWINGS

FIG. 1 is a perspective view illustrating a structure in which a metal tab is joined onto an electrode tab, according to at least one embodiment of the present disclosure.

FIG. 2 is a perspective view illustrating that the metal tab has been joined on the electrode tab according to the example of FIG. 1.

FIG. 3 is a perspective view illustrating a structure in which a metal tab is joined onto an electrode tab, according to at least one other embodiment of the present disclosure.

FIG. 4 is a perspective view illustrating a structure in which an electrode lead having a bending structure has been joined on a metal tab, according to at least one other embodiment of the present disclosure.

FIG. 5 illustrates a structure in which a current collector of an outermost electrode among electrodes included in an electrode assembly is placed to have a relatively low Young's modulus, according to at least one other embodiment of the present disclosure.

FIG. 6 is a graph showing the results of bending tests on a battery having a metal tab, according to at least one embodiment of a battery without having a metal tab.

FIG. 7 is a table showing materials and Young's moduli of a metal tab, an electrode and an electrode lead, according to embodiments of the present disclosure.

FIG. 8 illustrates how to perform a stress test on a metal tab, a current collector of an electrode and an electrode lead, according to embodiments of the present disclosure.

FIG. 9 is graph showing the degree of breakage and cutting in a current collector of an electrode, an electrode lead and a tab-lead provided portion based on the stress and displacement measured from each of a metal tab, the current collector of an electrode and the electrode lead which are components of a battery, when a young's modulus of the current collector of the first electrode is lower than a young's modulus of the current collector of the second electrode.

FIG. 10 is graph showing the degree of breakage and cutting in a current collector of an electrode, an electrode lead and a tab-lead provided portion based on the stress and displacement measured from each of a metal tab, the current collector of an electrode and the electrode lead which are components of a battery, when a young's modulus of the current collector of the first electrode, and a young's modulus of the current collector of the second electrode are same.

### BEST MODE FOR CARRYING OUT THE INVENTION

Hereafter, a flexible battery according to the present disclosure will be described with reference to the accompanying drawings.

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not intended to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

Further, in describing components of the present disclosure, terms such as first, second, A, B, (a), (b), etc. can be used. These terms are used only to differentiate the components from other components. Therefore, the nature, order, sequence, etc. of the corresponding components are not limited by these terms. It is to be understood that when one element is referred to as being “connected to” or “coupled to” another element, it may be directly connected or coupled to another element or be connected or coupled to another element, having still another element “connected” or “coupled” therebetween.

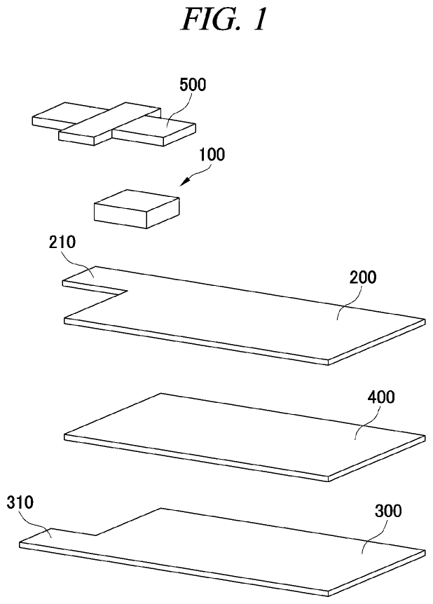

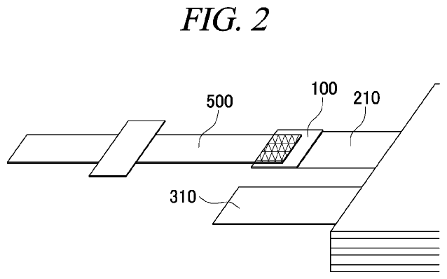

FIG. 1 is a perspective view illustrating that a metal tab is joined onto an electrode tab according to an embodiment of the present disclosure. FIG. 2 is a perspective view illustrating that the metal tab has been joined on the electrode tab according to the illustration of FIG. 1.

Referring to FIG. 1 and FIG. 2, a metal tab 100 according to the present disclosure is used in a lithium secondary battery including a first electrode 200 and a second electrode 300 having different polarities with a separator 400 interposed therebetween. A current collector of the first electrode 200 of the two electrodes has a Young's modulus equal to or lower than that of a current collector of the second electrode 300.

When the current collector of the first electrode 200 has a Young's modulus lower than that of the current collector of the second electrode 300, the current collector of the first electrode 200 may be made of copper and the current collector of the second electrode 300 may be made of stainless steel.

Further, when the current collector of the first electrode 200 has a Young's modulus lower than that of the current collector of the second electrode 300, the current collector of the first electrode 200 may be made of aluminum and the current collector of the second electrode 300 may be made of stainless steel.

Meanwhile, when the current collector of the first electrode 200 has the same Young's modulus as the current collector of the second electrode 300, the current collector of the first electrode 200 may be made of aluminum and the current collector of the second electrode 300 may be made of aluminum.

The metal tab 100 according to the present disclosure is welded on a first electrode tab 210 protruding for electrical connection from the first electrode 200. In an embodiment of the present disclosure, the metal tab 100 is not used in the current collector of the second electrode 300 having a higher Young's modulus than the current collector of the first electrode 200. This is because a separation problem between an electrode lead and an electrode caused by a bending stress occurs mainly in the first electrode 200.

In an embodiment of the present disclosure, a Young's modulus of the metal tab 100 is equal to or greater than that of the current collector of the first electrode 200, but desirably equal to or less than that of an electrode lead 500.

In an embodiment of the present disclosure, the bending stress is controlled by the thickness, and FIG. 1 illustrates that the metal tab 100 has a thickness from one to five times greater than that of the current collector of the first electrode 200.

In accordance with at least one embodiment described and recited herein, the metal tab 100 having the above-described thickness is joined on the current collector of the first electrode 200, and the metal tab 100 may effectively absorb a stress generated when the electrode lead 500 having a high Young's modulus is bent. If the metal tab 100 has a thickness less than one time of the current collector of the first electrode 200, a portion between the electrode lead 500 and the first electrode tab 210 may be easily cut without the effect by providing the metal tab 100, and if the metal tab 100 has a thickness more than five times, when the metal tab 100 is provided on the electrode tab 210 of the first electrode 200, adhesion decreases, and if the intensity of ultrasonic waves increases to improve adhesion, the metal tab 100 melts in part and sticks to a horn and an anvil. As such, the difficulty increases and the workability decreases. Also, the quality is not uniform. Further, the electrode tab 210 that is an uncoated portion under a tab-lead provided portion where the electrode lead 500 and the electrode tab of the first electrode 200 are provided can be easily cut when bent.

In at least one embodiment of the present disclosure, the lithium secondary battery is a flexible lithium secondary battery having bendability, and a maximum bend angle of the lithium secondary battery has an internal angle in the range of from 10° to 180°. That is, the metal tab 100 disposed between the first electrode tab 210 and the electrode lead 500 relieves a stress incurred in a flexible lithium secondary battery, particularly a tear or separation of the thin current collector (e.g., copper) of the first electrode 200 when the thick electrode lead (e.g., nickel) is also bent.

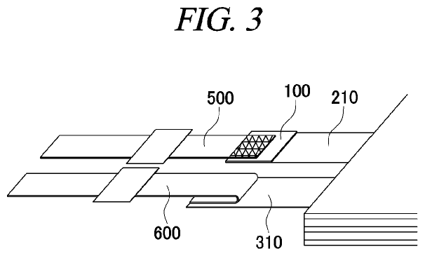

FIG. 3 is a perspective view illustrating a structure in which a metal tab is joined onto an electrode tab according to another embodiment of the present disclosure.

Referring to FIG. 3, the metal tab 100 is used in the lithium secondary battery that includes the first electrode 200 and the second electrode 300 having different polarities with the separator 400 interposed therebetween, and the current collector of the first electrode 200 has a Young's modulus that is equal to or less than that of the current collector of the second electrode 300.

A second electrode lead 600 has a bending structure that may be bent 180° in an opposite direction toward the outside of an electrode assembly when provided on the second electrode tab 310 protruding for electrical connection from the second electrode 300 toward the electrode assembly.

When the current collector of the first electrode 200 has a Young's modulus less than the current collector of the second electrode 300, the second electrode lead 600 is provided onto the second electrode tab 310; and Young's moduli of the current collector of the first electrode 200, the current collector of the second electrode 300, the metal tab 100, the first electrode lead 500 and the second electrode lead 600 satisfy the relationship that a young's modulus of the second electrode 300 is equal to or larger than a young's modulus of the first electrode lead 500, the young's modulus of the first electrode lead 500 is equal to or larger than a young's modulus of the metal tab 100, the young's modulus of the metal tab 100 is equal to or larger than a young's modulus of the first electrode 200, the young's modulus of the first electrode 200 is equal to or larger than a young's modulus of the second electrode lead 600.

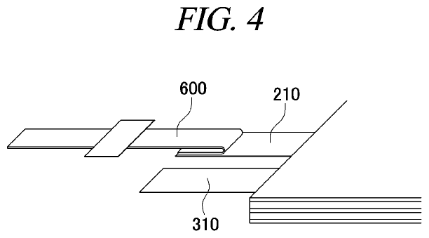

FIG. 4 is a perspective view illustrating a structure in which an electrode lead having a bending structure has been joined on a metal tab according to yet another embodiment of the present disclosure.

Referring to FIG. 4, when the current collector of the first electrode 200 has the same Young's modulus as the first electrode lead 500, the first electrode lead 500 may also bend.

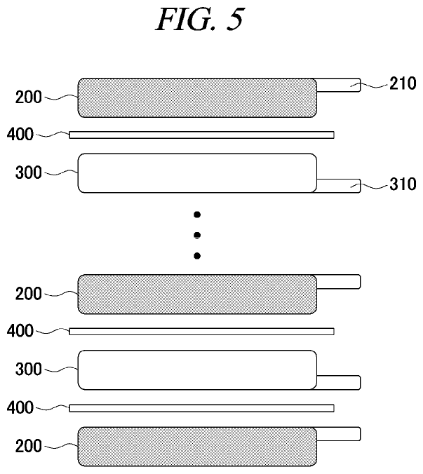

FIG. 5 illustrates a structure in which a current collector of an outermost electrode among electrodes included in an electrode assembly is placed to have a relatively low Young's modulus according to yet another embodiment of the present disclosure.

The electrode assembly has a structure in which the first electrode 200 and the second electrode 300 have different polarities and are alternately stacked with a separator interposed therebetween.

In this structure, as a pair of outermost electrodes included in the electrode assembly, the first electrode 200 including the current collector having a relatively low Young's modulus may be placed. Each of the pair of outermost electrodes may have a single surface coated with an electrode mixture.

Meanwhile, as for at least any one of the pair of outermost electrodes each including an electrode tab, a metal tab is provided on the electrode tab.

Further, the lithium secondary battery includes mixture layers having different polarities and coated on the current collectors of the first and second electrodes 200 and 300, respectively, and electrode tabs not coated with the mixture layers and placed on the current collectors of the first and second electrodes 200 and 300, respectively. The lithium secondary battery is sealed in a pouch including an electrode lead portion that is provided on the electrode tab and protruded to the outside of the lithium secondary battery to make electrons flow.

Hereinafter, Young's modulus applied to the present disclosure will be described.

A material having a high Young's modulus is stiff and highly resistant to deformation, and thus has solidity and low flexibility.

A material having a low Young's modulus is soft and less resistance to deformation and thus has fragility and high flexibility. Therefore, when a battery is bent by an external force, cutting of an outermost electrode less occurs.

Meanwhile, if the thickness is too thin, the breakage may easily occur. Therefore, an appropriate thickness needs to be applied. Further, when an external force is applied to electrodes made of different materials from each other and alternately stacked, an electrode having a relatively low Young's modulus is selectively broken first, and, thus, an appropriate Young's modulus needs to be found in consideration of thickness to secure flexibility.

Further, for example, as for copper (Cu) and stainless steel (SUS), SUS is more expensive than Cu, and, thus, it is more cost-efficient to apply Cu to outermost electrodes including a relatively large number of electrodes and reduce manufacturing costs.

Also, the outermost electrodes do not contribute to the capacity of the battery, but rather take up a thickness and thus decrease energy density. Therefore, desirably, an electrode mixture is coated on a single surface.

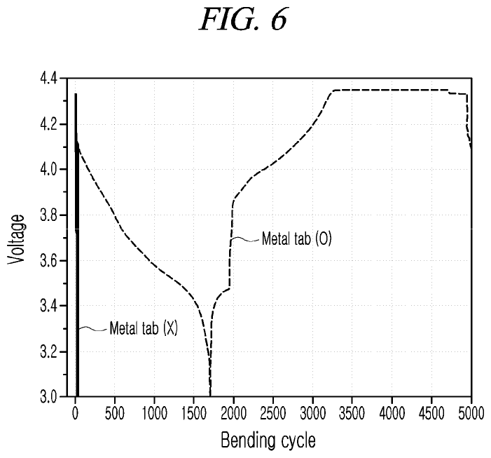

FIG. 6 is a graph showing the results of bending tests on a battery having a metal tab according to an embodiment of the present disclosure and a battery without having a metal tab.

Referring to FIG. 6, a charge/discharge test and a bending test are performed at the same time. As a result thereof, an electrode and a lead in the conventional battery without having the metal tab 100 are broken before bending 30 times and the battery having the metal tab 100 can perform a normal electrochemical operation even after bending 5000 times.

In many cases, a conventional lithium secondary battery is easily cut at a terminal portion by an external impact or force and thus sharply decreases in capacity and cannot function as a battery.

However, by understanding the characteristics of the materials of the components, such as the metal tab 100, the electrodes 200 and 300 and the electrode leads 500 and 600, included in the battery and improving the structure, it is possible to enhance the durability of an electrode at a terminal portion of the lithium secondary battery where breakage and cutting occurs most easily due to bending and distortion which is a repeatedly applied force from the outside.

In the present disclosure, a simple process of providing (spot providing, ultrasonic providing, laser providing, joining with conductive adhesive, etc.) the small metal tab 100 on an electrode tab based on the first electrode 200 and the second electrode 300 having different polarities has a great effect on the flexibility of the terminal portion.

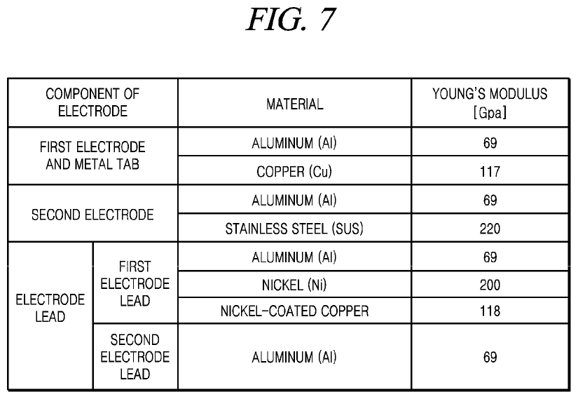

FIG. 7 is a table showing materials and Young's moduli of a metal tab, an electrode and an electrode lead according to an embodiment of the present disclosure.

As illustrated in FIG. 7, if an embodiment is prepared using the first electrode 200 as an negative electrode and the second electrode 300 as a positive electrode, the components can be assorted by setting Young's moduli using aluminum, copper, stainless steel and nickel as the materials.

Meanwhile, Young's modulus is a coefficient indicating how much a relative length of an elastic object is changed by an external force (stress). This is not relevant to the shape of the object but only relevant to the material of the object.

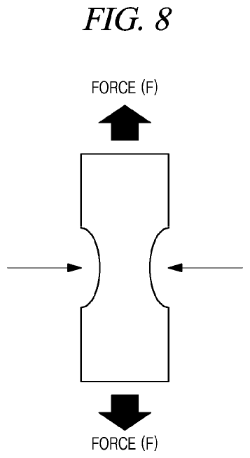

FIG. 8 illustrates to perform a stress test on a metal tab, a current collector of an electrode and an electrode lead according to an embodiment of the present disclosure. Referring to FIG. 8, in a stress test on the battery having the metal tab 100, when force is applied to both ends of the battery, the battery material gradually decreases in the cross-sectional area and then is cut. In this case, the battery material generates an internal force resistant to the pulling force from the outside, and the stress is defined by dividing the resistant force by the cross-sectional area.

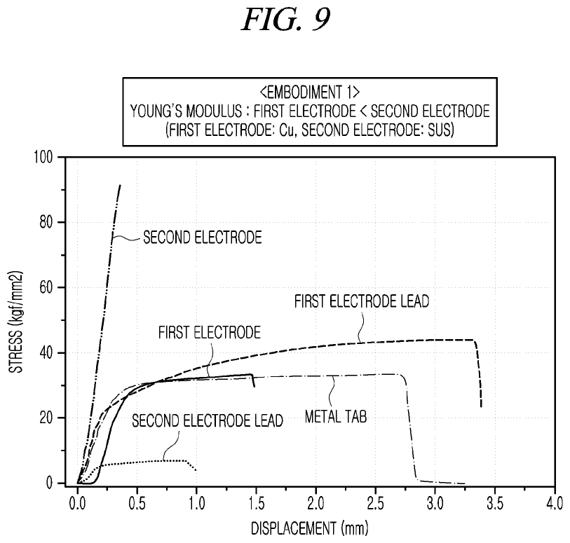

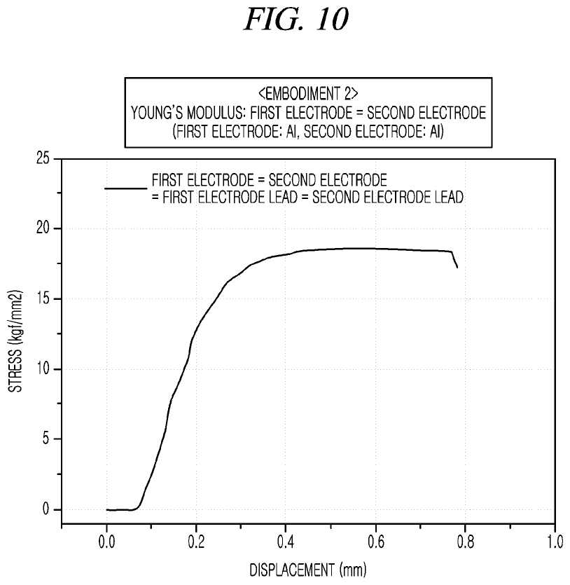

FIG. 9 and FIG. 10 are graphs showing the degree of breakage and cutting in a current collector of an electrode, an electrode lead and a tab-lead provided portion based on the stress and displacement measured from each of a metal tab, the current collector of an electrode and the electrode lead which are components of a battery as a result of the stress test performed as illustrated in FIG. 8.

FIG. 9 is a graph showing the stress and displacement just before the current collectors of the respective electrodes, the metal tab 100, the first electrode lead 500 and the second electrode lead 600 are broken and cut in an embodiment in which the current collector of the first electrode 200 is made of copper, the current collector of the second electrode 300 is made of stainless steel, the current collector of the first electrode 200 has a lower Young's modulus than the current collector of the second electrode 300. As for the current collector of the first electrode 200 which is made of copper, it continues to stretch at a stress of about 30 kgf/mm² and is cut at a displacement of about 1.5 mm. As for the current collector of the second electrode 300 which is made of stainless steel, unlike copper, it tends to be highly resistant to the pulling force from the outside rather than be stretched.

FIG. 10 shows the relationship between the stress and displacement in another embodiment in which the current collector of the first electrode, the current collector of the second electrode, the first electrode lead and the second electrode lead are made of aluminum.

Therefore, by using the metal tab 100 for reinforcement and the tab of the bending structure and applying appropriate Young's moduli and thicknesses to the electrode current collectors of the respective electrodes, it is possible to improve a weak portion which can be easily broken by an external force and secure the flexibility of the battery.

We claim:

1. A metal tab included in a lithium secondary battery, the lithium secondary battery comprising:
a first electrode,
a second electrode, and
a separator interposed therebetween, and
the metal tab is provided on a first electrode tab connected with the first electrode, and
a current collector of the first electrode has a Young's modulus equal to or less than that of a current collector of the second electrode.

2. The metal tab of claim 1,
wherein when the current collector of the first electrode is made of aluminum, the current collector of the second electrode is made of aluminum or stainless steel.

3. The metal tab of claim 1,
wherein when the current collector of the first electrode is made of copper, the current collector of the second electrode is made of stainless steel.

4. The metal tab of claim 1,
wherein a bend angle of the lithium secondary battery bends at an internal angle in the range of from 10° to 180°.

5. The metal tab of claim 1,
wherein the metal tab is made of a metal having a Young's modulus equal to or greater than that of the current collector of the first electrode and has a thickness equal to or greater than that of the current collector of the first electrode.

6. The metal tab of any one of claim 1,
wherein in the lithium secondary battery, a first electrode lead is provided on the metal tab, and
Young's moduli of the current collector of the first electrode, the metal tab and the first electrode lead satisfy the relationship that a young's modulus of the first electrode lead is equal to or larger than a young's modulus of the metal tab, and the young's modulus of the metal tab is equal to or larger than a young's modulus of the current collector of the first electrode.

7. The metal tab of claim 1,
wherein a second electrode lead provided on a second electrode tab connected with the second electrode has a bending structure.

8. The metal tab of claim 1,
wherein a second electrode lead is provided on a second electrode tab protruded and extended from the second electrode, and
Young's moduli of the current collector of the first electrode, the current collector of the second electrode, the metal tab, the first electrode lead and the second electrode lead satisfy the relationship that the a young's modulus of the current collector of the second electrode is equal to or larger than a young's modulus of the first electrode lead, the young's modulus of the first electrode lead is equal to or larger than a young's modulus of the metal tab, the young's modulus of the metal tab is equal to or larger than a young's modulus of the current collector of the first electrode, and the young's modulus of the current collector of the first electrode is equal to or larger than a young's modulus of the second electrode lead.

9. The metal tab of claim 1,
wherein if the current collector of the first electrode has the same Young's modulus as a first electrode lead, the first electrode lead has a bending structure.

10. The metal tab of claim 1,
wherein an electrode assembly included in the lithium secondary battery includes a first electrode and a second electrode alternately stacked with a separator interposed therebetween, and
a pair of outermost electrodes placed on both sides of the electrode assembly includes a first electrode coated with an electrode mixture.

11. The metal tab of claim 10,
wherein a metal tab is provided on at least one of electrode tabs of the pair of outermost electrodes.

12. The metal tab of claim 6,
wherein the lithium secondary battery includes mixture layers coated on the current collectors of the first and second electrodes, respectively, and electrode tabs not coated with the mixture layers and placed on the current collectors of the first and second electrodes, respectively, and
the lithium secondary battery is sealed in a pouch including an electrode lead portion that is formed on the electrode tab and protruded to the outside of the lithium secondary battery.
